(19) United States
(12) Patent Application Publication
(10) Pub. No.: US 2010/0045237 A1
(43) Pub. Date: Feb. 25, 2010

(54) MULTIFUNCTIONAL PORTABLE ENERGY STORAGE DEVICE

(75) Inventor: JIALONG LIU, Shenzhen (CN)

Correspondence Address: G. LINK CO., LTD., 3550 BELL ROAD, MINOOKA, IL, 60447, US

(73) Assignee: Shenzhen Elite Electronic Co., Ltd, Shenzhen (CN)

(21) Appl. No.: 12/194,555

(22) Filed: Aug. 20, 2008

(51) Int. Cl. H02J 7/00

(52) U.S. Cl. 320/128

(57) ABSTRACT

A multifunctional portable energy storage device, particularly, an energy storage device with functions of electric quantity storage, AC and DC charging, electric quantity detection, and DC boost output is provided, which is applicable for AC and DC bidirectional charging. The energy storage device includes an electrical core, a charging interface, and a powering interface. An external power supply charges the electrical core through the charging interface, and the electrical core supplies power to an external device through the powering interface. The energy storage device further includes an AC/DC converter, a control unit, and a charging management unit. The charging interface is connected to an input terminal of the AC/DC converter. An external AC current is converted into a DC current by the AC/DC converter and then input to the charging management unit. The charging management unit controls the DC current and supplies power to the electrical core, and the electrical core supplies power to the external device through the powering interface. The control unit controls the operations of the charging management unit. The present invention has a simple structure and can be used flexibly, which brings a lot of conveniences to users.

### BACKGROUND OF THE INVENTION

1. Field of the Invention

The present invention relates to an energy storage device, and more particularly to an energy storage device with functions of electric quantity storage, AC and DC charging, electric quantity detection, and DC boost output, which is applicable for AC and DC bidirectional charging.

2. Related Art

Recently, in the common technical field of portable energy storage devices (i.e., POWERBANK), a built-in electrical core is usually taken as an energy storage device. The electrical core is charged by a special charger to store electric energy, and in usage, the electrical core outputs the electric energy. After being boosted by a boost circuit, the output voltage is raised to 5V, so as to supply power to an external device. The energy storage device in the prior art still has defects, that is, the energy storage device in the prior art can only charge the built-in electrical core in a manner of supplying with a DC current. Therefore, if a failure occurs to the configured charger or no special charge adapter is available, the energy storage device cannot be charged. Meanwhile, it is inconvenient for a user to take along a fitted charger or charge adapter when going out. The energy storage device in the prior art does not have an electric quantity detection function, so that the user cannot figure out the remaining electric quantity before going out, which is rather inconvenient. The energy storage device in the prior art cannot be discharged when being charged, cannot be charged when being discharged, and cannot be discharged through a USB port, which lacks of flexibility in usage.

### SUMMARY OF THE INVENTION

In view of the above defect in the prior art that the portable energy storage device can merely be charged with a DC current, the present invention is directed to a novel portable energy storage device, which is connected to a buck circuit, an AC/DC conversion circuit, and a regulator circuit at an input interface. A high-voltage commercial AC current is converted into a low-voltage DC current, and then regulated by the regulator circuit, and then used to charge an electrical core in the present invention, so that the portable energy storage device of the present invention can be charged with either an AC current or a DC current.

A control unit in the present invention is further connected to a light-emitting diode (LED) for indicating the remaining electric quantity in the electrical core of the present invention, so as to solve the problem in the prior art that the portable energy storage device cannot indicate the electric quantity in the electrical core. The present invention is further configured with an input USB port connected to a charging management unit, so that the present invention is charged through the USB port. The present invention is further configured with an output USB port connected to a powering interface in parallel, so that the power is output through the USB port.

The technical solution provided in the present invention for solving the technical problem is described as follows. A multifunctional portable energy storage device is provided, which includes an electrical core, a charging interface, and a powering interface. An external power supply charges the electrical core through the charging interface, and the electrical core supplies power to an external device through the powering interface. The energy storage device further includes an AC/DC converter, a control unit, and a charging management unit. The charging interface is connected to an input terminal of the AC/DC converter. An external AC current is converted into a DC current by the AC/DC converter and then input to the charging management unit. The charging management unit controls the DC current and supplies power to the electrical core. The electrical core supplies power to the external device through the powering interface. The control unit controls operations of the charging management unit.

The technical solution provided in the present invention for solving the technical problem further includes the following aspects.

The energy storage device further includes: an input USB port, connected to a power input terminal of the charging management unit and the powering interface respectively.

The AC/DC converter includes a buck portion, an AC/DC conversion portion, and a regulator portion. The external AC current is bucked in voltage by the buck portion and input to the AC/DC conversion portion, then converted into the DC current by the AC/DC conversion portion and input to the regulator portion, such that a stable voltage is output to the charging management unit.

The buck portion employs a resistance/capacitance (R/C) buck circuit.

A data terminal of the control unit is connected to two or more LEDs for indicating electric quantity of the electrical core.

A fuse is connected on a live wire of the charging interface in series.

The energy storage device further includes: an output USB port, connected to the powering interface in parallel.

A field effect transistor (FET) is respectively disposed between the input USB port and the powering interface and between the charging management unit and the powering interface, and a control terminal of each FET is respectively connected to the data terminal of the control unit.

The efficacies of the present invention are listed as follows: the present invention has a simple structure and multiple functions, and can be charged with an external AC current, an external DC current, or charged by the computer through the USB port, which thus has various charging manners and is flexible in usage. The present invention is further configured with an electric quantity indicator, which enables the user to easily figure out the electric quantity of the electrical core in the present invention. The present invention is further configured with a battery over-discharge protection module and an output over-current protection module, for protecting the present invention from being damaged. The present invention can supply power to the external device through the powering interface or the USB port, thus having flexible supplying manners.

The present invention is illustrated below in detail with reference to the accompanied figures and specific embodiments.

### BRIEF DESCRIPTION OF THE DRAWINGS

The present invention will become more fully understood from the detailed description given herein below for illustration only, and thus is not limitative of the present invention, and wherein:

FIG. 1 is a block circuit diagram of the present invention.

FIG. 2 is a circuit principle diagram of the present invention.

### DETAILED DESCRIPTION OF THE INVENTION

The following embodiment is merely a preferred embodiment of the present invention, others embodiments with principles and basic structures the same as or similar to this

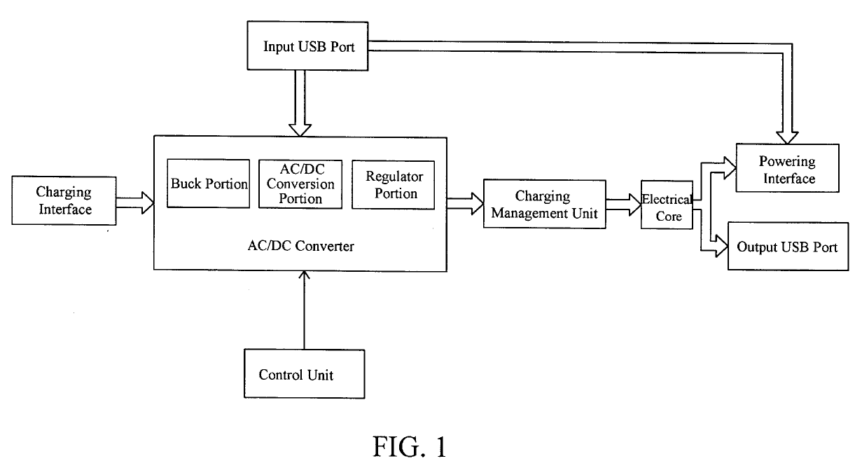

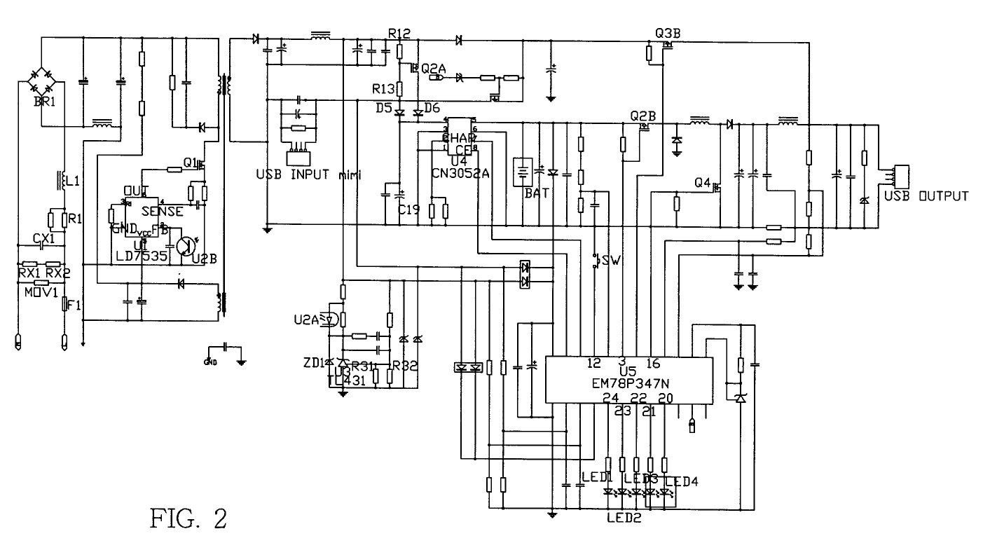

embodiment also fall within the scope sought to be protected by the present invention. Referring to FIGS. 1 and 2, the energy storage device of the present invention mainly includes an AC/DC converter, a control unit, a charging management unit, a charging interface, a powering interface, and an electrical core. The charging interface, the powering interface, and the electrical core are the same as those in the prior art. The electrical core is used as a storage element in the present invention for storing energy. The present invention supplies power in a form of a commercial AC current, and the commercial AC current is bucked in voltage by the buck portion and then input to the AC/DC conversion portion. In this embodiment, the buck portion employs an R/C buck circuit. A resistor RX1 and a resistor RX2 are connected between a neutral wire and a live wire in series, and are connected to a capacitor CX1 in parallel. A resistor R1 and an inductor L1 are connected on the live wire in series. In the present invention, the commercial AC current is converted into a low-voltage AC current through the above circuit, and then input to the AC/DC conversion portion. In order to prevent the present invention from being damaged by a high-voltage pulse, in this embodiment, a voltage-sensitive resistor MOV1 is connected between the neutral wire and the live wire in series, and a fuse F1 is connected on the live wire in series for power input, so as to prevent the present invention from being damaged due to the over-current. The commercial AC current with the voltage bucked by the buck portion is converted into an approximately low-voltage DC by a bridge rectifier, input to an AC/DC chip U1 to be converted into a DC current, and then output to the regulator portion. In this embodiment, the AC/DC chip U1 employs a LD7535 chip. In this embodiment, the regulator portion is formed by an optical coupler U2 and an adjustable regulated power supply U3. An LED and a zener diode ZD1 in the optical coupler U2 are connected between a positive pole of the power supply and the ground in series. A photosensitive triode in the optical coupler U2 is connected to an FB pin in the AC/DC chip U1. A power output pin OUT of the AC/DC chip U1 is connected to a control terminal of a field effect transistor Q1, and the field effect transistor Q1 is connected between a SENSE pin of the AC/DC chip U1 and the positive pole of the power supply. In this embodiment, the adjustable regulated power supply U3 employs a 3-terminal adjustable shunt voltage regulator TL431. An adjustment control terminal of the adjustable regulated power supply U3 is connected to a resistor R31 and a resistor R32 in series, so that an output voltage of the adjustable regulated power supply U3 can be accurately adjusted and controlled by adjusting the resistor R31 and the resistor R32. The adjustable regulated power supply U3 outputs power to the charging management unit. In this embodiment, a core chip of the charging management unit employs a lithium battery charger circuit U4, and the lithium battery charger circuit U4 employs a CN3052A chip. A positive power input terminal of the lithium battery charger circuit U4 is connected to the positive pole of the power supply through a diode D6 and a field effect transistor Q2A connected in series. A control terminal of the field effect transistor Q2A is connected between a resistor R12 and a resistor R13, and the resistor R12 and the resistor R13 are connected in series. The resistor R12 is connected to the positive pole of the power supply, and the resistor R13 is grounded through a diode D5 and a capacitor C19 connected in series. An anode of the diode D5 is connected to the resistor R13. A common terminal of the resistor R13 and the diode D5 is connected to the positive pole of the power supply through a field effect transistor Q3A. A cathode of the diode D5 is connected to the positive power input terminal of the lithium battery charger circuit U4. A positive pole of the powering interface is connected to the positive pole of the power supply sequentially through a zener diode ZD5, a resistor R14, and a resistor R15 connected in series. A control terminal of the field effect transistor Q3A is connected to a common terminal of the resistor R14 and the resistor 15. When no electrical equipments is connected to the powering interface, the field effect transistor Q3A is turned off, the field effect transistor Q2A is turned on, and the positive power supply supplies power to the lithium battery charger circuit U4 through the field effect transistor Q2A. When certain electrical equipment is connected to the powering interface, the field effect transistor Q3A is turned on, and then, the field effect transistor Q3A drags the control terminal of the field effect transistor Q2A down to a low level. At this time, the field effect transistor Q2A is turned off, and the positive power supply stops supplying power to the lithium battery charger circuit U4, but directly outputs the power to the powering interface. A BAT terminal of the lithium battery charger circuit U4 is connected to a positive pole of the electrical core, for supplying power to the electrical core. In this embodiment, the electrical core employs a lithium battery BAT. A chip enable (CE) terminal and a charging status indicator terminal CHAR of the lithium battery charger circuit U4 are respectively connected to a data terminal of a single-chip processor U5. The single-chip processor U5 controls operations of the lithium battery charger circuit U4 and is used to identify a charging status of the lithium battery charger circuit U4. The present invention further includes a control unit, and the core of the control unit is the single-chip processor U5. In this embodiment, the single-chip processor U5 employs a single-chip processor chip of Model EM78P347N. The control unit controls the overall operations of the present invention. A data terminal of a third pin of the single-chip processor U5 is connected to a control terminal of a field effect transistor Q2B. The field effect transistor Q2B is connected between the positive pole of the electrical core and the positive pole of the powering interface in series, for controlling whether the electrical core supplies power to the external equipment or not. A data terminal of a sixteenth pin of the single-chip processor U5 is connected to a control terminal of a field effect transistor Q4. The field effect transistor Q4 is connected between the positive pole and the negative pole of the electrical core. In an emergency, the single-chip processor U5 controls to turn on the field effect transistor Q4, so as to prevent the present invention from being damaged. A data terminal of a twelfth pin of the single-chip processor U5 is connected to a switch SW for turning on/off and inputting control commands to the present invention. In this embodiment, the data terminal, a twentieth pin, and a twenty-first pin of the single-chip processor U5 are connected to a dual-color LED LED4. A twenty-second pin is connected to an LED3. A twenty-third pin is connected to an LED2. A twenty-fourth pin is connected to an LED1. The LED1, LED2, and LED3 are used to indicate a capacity of the battery, which is helpful for the user to determine the electric quantity of the electrical core in the present invention. In this embodiment, when the electric quantity of the electrical core is less than 10%, the LED1, LED2, and LED3 are all turned off; when the electric quantity of the electrical core is 10%-40%, the LED1 is turned on, and the LED2 and LED3 are turned off; when the electric quantity of the electrical core is 40%-70%, the LED1 and LED2 are turned on, and the LED3 is turned off; when the electric quantity of the electrical core is 70%-100%, the LED 1, LED2, and LED3 are all turned on. The LED4 is used to indicate the charging status in the present invention, in which when the electrical core is in a charging status, the red light of the LED4 is turned on; after the charging is finished, the green light of the LED4 is turned on.

In order to enable the present invention to become more flexible, a USB port is added as a power input interface, in which a positive pole of the USB port is connected to the positive power input terminal of the lithium battery charger circuit U4 through the diode D5, and a negative pole of the USB port is grounded. In this embodiment, the input USB port is a mini USB port. Another USB port is further added in the present invention as a power output interface, in which the output USB port is connected to the powering interface in parallel. A field effect transistor Q3B is connected between the output USB port and the powering interface, in which a control terminal of the field effect transistor Q3B is connected to a data terminal of a first pin of the single-chip processor U5. Therefore, the single-chip processor U5 controls to output power through the USB port, or through both the powering interface and the output USB port.

In usage, three power supply manners may be adopted in the present invention: 1. supply with a DC current; 2. supply with an AC current; and 3. supply through USB. Since the buck portion in the present invention bucks the voltage through an R/C buck circuit instead of a transformer, if the power is supplied with a DC current, an external DC source is directly connected to the charging interface. If the power is supplied with a commercial AC current, the commercial AC current is connected to the charging interface, and the high-voltage commercial AC current is bucked in voltage by the buck portion, and then rectified by the bridge rectifier BR1, so as to convert the AC current into an approximate DC current. After that, the process of supplying power with the DC current has the same operating mode as that of supplying power with the AC current. Particularly, an input power is output to a regulator module, processed by the AC/DC chip U1, and converted into a DC current, and then the DC current is output. Then, after being regulated by the adjustable regulated power supply U3, the power is output to the charging management unit, thereby charging the electrical core in the present invention. If the power is supplied through the USB, it merely needs to connect the input USB port of the present invention to the USB port of the computer through a USB data line, and the power is directly output to the charging management unit through the USB port, so as to charge the electrical core in the present invention. The present invention can directly supply power to the external device through the powering interface or the output USB port.

When being charged, the present invention is connected to a data terminal of the single-chip processor U5 through the charging status indicator terminal CHAR of the lithium battery charger circuit U4, so as to detect and identify the electric quantity of the electrical core in real time, and the electric quantity of the electrical core is displayed through the four LEDs connected to the single-chip processor U5.

The present invention is further configured with a switch SW, for switching the operation status of the present invention, such as turning on/off the battery boost function, and turning on/off the USB output, and the specific function settings are realized by the programs in the single-chip processor U5. When no input or output operation occurs for OS, the single-chip processor U5 automatically enters a sleep mode, and when an AC input or a DC input or a switching operation occurs, the single-chip processor U5 automatically wakes up.

The present invention can charge the internal electrical core with the AC current and DC current, and detect and display the energy stored in the internal electrical core. By adopting the standard output USB port, it is convenient to charge mobile phones and digital products of all models that are connected to the motherboard of the computer, and those products that cannot be connected to the motherboard of the computer can be charged through a randomly-fitted conversion adapter.

What is claimed is:

1. A multifunctional portable energy storage device, comprising: an electrical core, a charging interface, and a powering interface, wherein an external power supply charges the electrical core through the charging interface, and the electrical core supplies power to an external device through the powering interface; wherein the energy storage device further comprises an AC/DC converter, a control unit, and a charging management unit, wherein the charging interface is connected to an input terminal of the AC/DC converter, an external AC current is converted into a DC current by the AC/DC converter and then input to the charging management unit, the charging management unit controls the DC current and supplies power to the electrical core, the electrical core supplies power to the external device through the powering interface, and the control unit controls operations of the charging management unit.

2. The multifunctional portable energy storage device according to claim 1, further comprising: an input USB port, connected to a power input terminal of the charging management unit and the powering interface respectively.

3. The multifunctional portable energy storage device according to claim 1, wherein the AC/DC converter comprises a buck portion, an AC/DC conversion portion, and a regulator portion, the external AC current is bucked in voltage by the buck portion and input to the AC/DC conversion portion, then converted into the DC current by the AC/DC conversion portion and input to the regulator portion, such that a stable voltage is output to the charging management unit.

4. The multifunctional portable energy storage device according to claim 3, wherein the buck portion employs a resistance/capacitance (R/C) buck circuit.

5. The multifunctional portable energy storage device according to claim 1, wherein a data terminal of the control unit is connected to two or more light-emitting diodes (LEDs) for indicating an electric quantity of the electrical core.

6. The multifunctional portable energy storage device according to claim 1, wherein a fuse is connected to a live wire of the charging interface in series.

7. The multifunctional portable energy storage device according to claim 1, further comprising: an output USB port, connected to the powering interface in parallel.

8. The multifunctional portable energy storage device according to claim 1, wherein a field effect transistor (FET) is respectively disposed between the USB port and the powering interface and between the charging management unit and the powering interface, and a control terminal of each FET is respectively connected to a data terminal of the control unit.
